(19) United States
(12) Patent Application Publication
(10) Pub. No.: US 2011/0262614 A1
(43) Pub. Date: Oct. 27, 2011

(54) SAPONIN WITH SUPPRESSED BITTER TASTE

(75) Inventors: Tadashi Hamajima, Osaka (JP); Morihiro Aoyagi, Osaka (JP); Seiji Yahara, Osaka (JP); Kazunori Sonobe, Osaka (JP); Akiko Kamoi, Osaka (JP)

(73) Assignee: HOUSE FOODS CORPORATION, Osaka (JP)

(21) Appl. No.: 13/142,128

(22) PCT Filed: Dec. 24, 2009
(86) PCT No.: PCT/JP2009/071381

§ 371 Date: Jun. 24, 2011

(30) Foreign Application Priority Data
Dec. 25, 2008 (JP) 2008-329858

(51) Int. Cl. A23L 2/00; A23L 1/48; C08B 37/16

(52) U.S. Cl. 426/590; 536/103; 426/658

(57) ABSTRACT

An object of the present invention is to provide a material containing a saponin wherein the bitterness peculiar to saponin is effectively suppressed. According to the present invention, a saponin, a phytosterol and/or a phytosterol ester, and a cyclodextrin are mixed to form a complex, so as to suppress bitterness. The complex of the present invention can be formed in the presence of water by mixing a saponin, a phytosterol and/or a phytosterol ester, and a cyclodextrin. The complex of the present invention can be contained in a composition such as a food or beverage.

### TECHNICAL FIELD

The present invention relates a complex containing saponin with decreased bitter taste, a method for producing the complex, and application of the complex to foods or beverages.

### BACKGROUND ART

One soy ingredient, saponin, is known to have functions of preventing excessive lipids and functions of improving hyperglycemia (Development of Functional Saccharine Material and Application to Foods, Kuniyo Inoue (Editorial Superviser) CMC Publishing CO., LTD. pp. 299-303).

However, saponins are problematic in that when a saponin is added in an amount expected to exert weight loss effects to a food, the food is tasted strong bitterness peculiar to saponin.

JP Patent Publication (Kokai) No. 5-64560 A (1993) discloses an invention relating to a method for producing bean curd, by which bitter taste can be removed from soybean by adding cyclodextrin and fats and oils to soy milk and then carrying out emulsification and mixing. In addition, in the Examples of JP Patent Publication (Kokai) No. 5-64560 A (1993), palm oil is used as an example of “fats and oils.” However, the present inventors confirmed that when a soybean saponin, palm oil, and a cyclodextrin were emulsified, mixed, and then pulverized, the bitter taste of the saponin was tasted and bitter taste could not be sufficiently suppressed. Also, when an emulsified mixture of a soybean saponin, palm oil, and a cyclodextrin was retorted or dried, bitter taste was tasted.

JP Patent No. 3246738 discloses technology for suppressing bitter taste of saponins isolated from soybean or the like by compounding the saponins with amino acids such as glutamic acid. However, amino acids are taste components that are generally also used as seasonings. Hence, the technology according to JP Patent No. 3246738 is problematic in that it has significant effects on the taste of foods and the like as final products, and thus it lacks versatility.

### SUMMARY OF THE INVENTION

### Problem to be Solved by the Invention

An object of the present invention is to provide a material containing a saponin with effectively suppressed bitterness peculiar to saponin.

Another object of the present invention is to provide a food or a beverage containing a saponin with suppressed bitter taste.

### Means for Solving the Problems

The present inventors have obtained the surprising finding that the bitterness peculiar to saponin can be suppressed by forming a complex of a saponin, a phytosterol and/or a phytosterol ester, and a cyclodextrin. Thus, the present inventors have completed the present invention. The present invention relates to the following (1) to (8).

(1) A complex, containing a saponin, a phytosterol and/or a phytosterol ester, and a cyclodextrin.
(2) The complex according to (1), which is produced by a method comprising a step of forming a complex by mixing a saponin, a phytosterol and/or a phytosterol ester, and a cyclodextrin in the presence of water.
(3) The complex according to (2), wherein the method further comprises a drying step for drying the complex formed by the step of forming a complex.
(4) A composition, comprising the complex according to any one of (1) to (3).
(5) A food or a beverage, comprising the complex according to any one of (1) to (3).
(6) The food or the beverage according to (5), which is subjected to heat sterilization.
(7) The food or the beverage according to (5) or (6), containing a soybean protein and 10 mg to 1000 mg of a saponin per serving.
(8) A method for producing a complex containing a saponin, a phytosterol and/or a phytosterol ester, and a cyclodextrin, comprising a step of forming a complex by mixing a saponin, a phytosterol and/or a phytosterol ester, and a cyclodextrin in the presence of water.
(9) The method according to (8), further comprising a drying step for drying the complex formed by the step of forming a complex.

This description includes part or all of the contents as disclosed in the description and/or drawings of Japanese Patent Application No. 2008-329858, which is a priority document of the present application.

### Effect of the Invention

Formation of a complex of a saponin, a phytosterol and/or a phytosterol ester, and a cyclodextrin makes it possible to suppress the bitterness peculiar to saponin.

### PREFERRED EMBODIMENTS OF THE INVENTION

### 1) Saponin

Saponins are steroids, steroid alkaloids, or triterpene glycosides. The term “saponin” is a generic name representing substances that dissolve in water so as to undergo soap-like foaming. Saponins broadly exist in plants. Saponins to be used in the present invention may be derived from any plants. Typical examples of saponins include soybean-derived saponins.

As soybean-derived saponins, more specifically, the ethanol-extracted fractions of soybean seeds or embryonic axes of soybean seeds can be used. Examples of typical names of substances include Soyasaponin Ab and Soyasaponin Bb. These saponins are marketed, such as in the case of Soyhealth SA (Fuji Oil Co., Ltd.).

### 2) Phytosterol

Vegetable sterols are cyclic higher alcohols having a steroid backbone with 1 to 2 double bonds, a hydroxyl group at position C-3, and a hydrocarbon side chain at position C-17, and they are contained in plants. Examples of general phytosterols include sterols contained in vegetable fats and oils. For example, such a phytosterol is extracted and purified from fats and oils of plants such as soybean, rapeseed, and cottonseed. Specific examples of phytosterols include β-sitosterol, campesterol, stigmasterol, brassicasterol, fucosterol, and dimethyl sterol, as well as mixtures of such compounds. For example, a soybean sterol contains sitosterol accounting for 53% to 56%, campesterol accounting for 20% to 23%, and stigmasterol accounting for 17% to 21% thereof. As a vegetable sterol, commercially available “phytosterol F” (Tama Biochemical Co., Ltd.) can also be used.

### 3) Phytosterol Ester

The term “phytosterol ester” refers to a substance that is obtained via ester bonding of fatty acids with hydroxyl groups in the sterol backbone of a vegetable sterol. An example of a method for producing a phytosterol ester is an enzymatic method using an enzyme. Any phytosterol ester can also be used in the present invention.

An example of such an enzymatic method comprises using lipase or the like as a catalyst and then mixing a phytosterol with fatty acids to react (at 30° C. to 50° C. for about 48 hours), thereby obtaining a phytosterol ester. Also, another example of a synthesis method comprises dehydrating a vegetable sterol generated from soybean or the like with fatty acids obtained from rapeseed oil, corn oil, or the like in the presence of a catalyst for esterification, so as to obtain a phytosterol ester.

The above phytosterols can be used as phytosterols composing phytosterol esters.

Fatty acids composing phytosterol esters may be derived from plants, such as rapeseed oil-derived or palm oil-derived esters or may be derived from animals. Examples of such phytosterol esters include myristic acid, stearic acid, palmitic acid, arachidonic acid, oleic acid, linoleic acid, α-linolenic acid, γ-linolenic acid, eicosapentaenoic acid, docosahexaenoic acid, palmitoleic acid, and lauric acid.

Examples of preferable phytosterol esters include a phytosterol ester composed of a soybean-derived phytosterol and a rapeseed oil-derived fatty acid and a phytosterol ester composed of soybean- and rapeseed-derived phytosterols and palm oil-derived fatty acid. An example of the former phytosterol ester is “San sterol No. 3” (San-Ei Gen F.F.I., Inc.) and an example of the latter phytosterol ester is “phytosterol fatty acid ester” (Tama Biochemical Co., Ltd.).

An amount of a phytosterol and/or a phytosterol ester to be used herein ranges from preferably about 10 to 1000 parts by weight with respect to 100 parts by weight of a saponin.

### 4) Cyclodextrin

The term “cyclodextrin” refers to a cyclic non-reduced maltooligosaccharide containing dextrose as a constitutional unit. As a cyclodextrin, any of α-cyclodextrin having 6 dextroses, β-cyclodextrin having 7 dextroses, and γ-cyclodextrin having 8 dextroses can be used. In particular, γ-cyclodextrin is preferable since it is degraded by a human digestive enzyme, has high solubility to water, and thus can be readily used in foods or beverages.

The amount of cyclodextrin to be used herein is preferably 50 parts by weight or more per 100 parts by weight of a saponin and more preferably ranges from 100 parts by weight to 100000 parts by weight of a cyclodextrin per 100 parts by weight of a saponin.

### 5) Production of Complex

A complex can be formed by mixing a saponin, a phytosterol and/or a phytosterol ester, and a cyclodextrin in the presence of water.

The order of addition or mixing of water, a saponin, a phytosterol and/or a phytosterol ester, and a cyclodextrin upon production of a complex is not particularly limited. For example, preferably, a saponin and a phytosterol and/or a phytosterol ester are mixed to form a mixture (and when dispersibility is poor, water is also mixed therewith), while a cyclodextrin is dispersed in water to form another mixture, and then both mixtures are mixed. However, the way of mixing is not limited to this example. For example, a saponin, a phytosterol and/or a phytosterol ester, a cyclodextrin, and water may be mixed simultaneously.

The amount of water to be allowed to coexist with the other substances upon formation of a complex ranges from preferably about 50 parts by weight to 10000 parts by weight per 100 parts by weight of a cyclodextrin.

The temperature upon formation of a complex may be any temperature as long as a phytosterol and/or a phytosterol ester has flowability, desirably ranging from about 40° C. to 80° C.

Regarding mixing of a saponin and a phytosterol and/or a phytosterol ester, any conditions or means for mixing may be employed, as long as appropriate dispersion can be achieved.

After a cyclodextrin is added and mixed, an apparatus having high shear force, such as a kneader is preferably used for sufficiently kneading the mixture so as to form a complex.

A complex formed by mixing is a pasty product containing moisture. Such a complex in paste form can be directly used by being added to a composition such as a food or a beverage. Also, such a pasty product may further be dried to remove moisture so as to prepare a dried product.

### 6) Production of Dried Product

A pasty complex obtained by the above step for forming a complex is dried, so that the dried complex can be produced.

Drying may be carried out by any method for drying, such as freeze drying, spray drying, and drum drying.

The thus dried complex is appropriately pulverized, so that the powdered complex can be obtained.

### 7) Characteristics of Complex and Other Ingredients

A saponin as a constituent of a complex formed according to the present invention has suppressed bitter taste. Furthermore, the complex of the present invention is thermally stable. For example, when the complex is combined with a food or a beverage containing water and then the resultant is heat sterilized, the effect of suppressing the bitter taste of saponins is maintained.

The complex of the present invention may be formed into any form. For example, an excipient may be used so that the powdery or granular complex can also be produced. Also, the complex may be in liquid form or paste form formed through dispersion or emulsification of the complex in a solvent such as water.

### 8) Composition

The complex of the present invention can be compounded with compositions in various forms such as foods or beverages, pharmaceutical preparations, and cosmetics. In particular, the complex is preferably compounded with a food or beverage composition.

Examples of foods or beverages to be compounded with the complex include, but are not particularly limited to, cooked foods including curry sauce, stew, pasta sauce, ingredients of chicken and egg bowls or beef bowls, sukiyaki, tofu, soup, potage, miso soup, plain soup, and wakame (seaweed) soup, and various processed foods including cookies or baked goods, tablets such as supplements, tablet sweets, powdered soup (e.g., consomme soup or mapo tofu powder soup prepared by adding hot water), and powdered beverages (e.g., cafe au lait, milk tea, cocoa, shake, or yogurt drink prepared by adding water). Foods or beverages subjected to heat sterilization such as retort sterilization or sterilization by chilling may also be used herein.

The complex of the present invention is preferably compounded with a food or a beverage so that the saponin intake per serving ranges from about 10 mg to 1000 mg in the food or beverage. With such an amount, the bitter taste of the saponin is effectively suppressed when the food or beverage is ingested. The “per serving” amount is appropriately determined depending on food or beverage type, such as 5 g to 500 g of a food or a beverage.

### EXAMPLES

### Raw Materials

### Saponin: Soyhealth SA (Fuji Oil Co., Ltd.)

Phytosterol ester: Sansterol No. 3 ES (San-Ei Gen F.F.I.)

### Cyclodextrin: CAVAMAX W8 Food (Cyclochem Co., Ltd.)

### Palm oil

### Water

TABLE 1

| | | | | | Comparative | | Comparative | | Comparative |
|---|---|---|---|---|---|---|---|---|---|
| | | | Example | | example 1 | | example 2 | | example 3 |
| Formulation | Mixture 1 | Saponin raw material (Fuji Oil | 5 | parts by weight | 5 | parts by weight | 5 | parts by weight | 5 parts by weight |
| | | Co., Ltd., “Soyhealth SA” | | | | | | | |
| | | Saponin content: about 50% by | | | | | | | |
| | | weight) | | | | | | | |
| | | Phytosterol ester (San-Ei Gen | 5 | parts by weight | — | | — | | — |
| | | F.F.I., Inc., “Sansterol No. 3”) | | | | | | | |
| | | Palm oil | — | | 5 | parts by weight | — | | — |
| | | Water | 7 | parts by weight | 7 | parts by weight | 7 | parts by weight | — |
| | Mixture 2 | γ-cyclodextrin (Cyclochem | 27 | parts by weight | 27 | parts by weight | 27 | parts by weight | — |
| | | Co., Ltd. “CAVAMAX W8 Food”) | | | | | | | |
| | | Water | 10 | parts by weight | 10 | parts by weight | 10 | parts by weight | — |

### Experiment 1

### Complex Prepared by Using Phytosterol Ester

### Example 1

Mixture 1 having the formulation in the Example shown in Table 1 was obtained by mixing a saponin, a phytosterol ester, and water at 60° C.

Mixture 2 having the formulation in the Example shown in Table 1 was obtained by mixing a cyclodextrin and water at 60° C.

Mixture 1 and mixture 2 were kneaded using a mixer at 60° C., so that a paste complex having the formulation in the Example was obtained.

The paste complex having the formulation in the Example was dried by maintaining it under an atmosphere at 80° C. for 10 hours, added to a mortar, and then stirred using a stirrer, so that a powdery product was obtained.

The thus obtained powdery product (14.8 g) was dissolved in 85.2 ml of water. Then a subject drank the solution but experienced almost no bitter taste.

### Comparative Example 1

A powdery product was obtained in a manner similar to that in Example 1 except that 5 parts by weight of palm oil was used instead of a phytosterol ester.

The thus obtained powdery product (14.8 g) was dissolved in 85.2 ml of water. Then a subject drank the solution and experienced a bitter taste.

### Comparative Example 2

The mixture obtained by mixing a saponin raw material, water, and a γ-cyclodextrin based on the formulation in Table 1 was dried in a manner similar to that in Example 1, added to a mortar, and then stirred with a stirrer, so that a powdery product was obtained.

The thus obtained powdery product (12.8 g) was dissolved in 87.2 ml of water. Then a subject drank the solution and experienced a bitter taste.

### Comparative Example 3

A saponin raw material (2.0 g) was dissolved in 98 ml of water. Then a subject drank the solution and strongly experienced a bitter taste.

### Experiment 2

### Example 2

A solution was obtained by dissolving 21.6 g of the paste complex having the formulation in the Example produced by the procedures described in Experiment 1 in 78.4 ml of water. A retort pouch was filled with 100 g of the solution, sealed, and then subjected to retort sterilization under conditions of 120° C. and 20 minutes.

A subject drank the thus obtained retort-sterilized solution, but experienced almost no bitter taste.

### Comparative Example 4

A retort-sterilized solution was obtained in a manner similar to that in Example 2, except that 5 parts by weight of palm oil was used instead of a phytosterol ester.

A subject drank the thus obtained retort-sterilized solution and experienced a bitter taste.

### Comparative Example 5

A mixture (19.6 g) was obtained by mixing 5 parts of saponin raw material, 17 parts of water, and 27 parts of γ-cyclodextrin, and it was then dissolved in 80.4 ml of water. Retort sterilization was carried out in a manner similar to that in Example 2.

A subject drank the thus obtained retort-sterilized solution and experienced a bitter taste.

### Comparative Example 6

A saponin raw material (2.0 g) was dissolved in 98.0 ml of water and then subjected to retort sterilization in a manner similar to that in Example 2. A subject drank the solution and strongly experienced a bitter taste.

### Experiment 3

### Chicken Curry Sauce

### Example 3

(1) Raw materials were mixed based on the formulation of a sauce (Table 2) and then heated to 95° C. while undergoing stirring, so that a sauce was prepared.
(2) Chicken meat and carrots to be used as ingredients were cut into bite-size pieces in advance and then boiled for 5 minutes.
(3) A retort pouch (126×170 mm) was filled with the resultant having the formulation in Table 3 and then sealed.
(4) Pressurized heat sterilization was carried out at 120° C. for 20 minutes.
(5) A subject ate the thus obtained chicken curry sauce, but experienced none of the bitterness peculiar to saponin.

### Comparative Example

Chicken curry was obtained by procedures similar to those in Example 3 except that 0.2 parts of a saponin raw material was compounded instead of a pulverized saponin complex.

A subject ate the chicken curry sauce and strongly experienced the bitterness peculiar to saponin.

TABLE 2
<Sauce formulation>

| Raw material | Weight (g) |
|---|---|
| Curry powder and spice | 2 |
| Common salt | 1 |
| Livestock meat extract | 3 |
| Tomato paste | 3 |
| Apple paste | 1 |
| Chutney | 4 |
| Seasoning | 2 |
| Ginger | 1 |
| Garlic | 0.3 |
| Sauteed onion | 2 |
| Starch | 3 |
| Flavor | 0.1 |
| Pulverized saponin complex* | 1.5 |
| Water | 76.1 |
| Total | 100 |

*The pulverized saponin complex in Example 1 in an amount corresponding to 0.1 g of a soybean saponin or 0.2 g of a saponin raw material (=Soyhealth SA)

TABLE 3
<Compounding via filling>

| Raw material | Weight (g) |
|---|---|
| Boiled chicken meat | 60 |
| Boiled carrot | 20 |
| Sauce | 100 |
| Total | 180 |

### Experiment 4

### Beef Stew

### Example 4

(1) Raw materials were mixed based on the formulation of a sauce (Table 4) and then heated to 95° C. while undergoing stirring, so that a sauce was prepared.
(2) Beef, mushrooms, and onions to be used as ingredients were cut into bite-size pieces in advance and then boiled for 5 minutes.
(3) A retort pouch (126×170 mm) was filled with the resultant having the formulation in Table 5 and then sealed.
(4) Pressurized heat sterilization was carried out at 120° C. for 20 minutes.
(5) A subject ate the thus obtained beef stew, but experienced none of the bitterness peculiar to saponin.

### Comparative Example

Beef stew was obtained in a manner similar to that in Example 4 except that 0.2 parts of a saponin raw material was compounded instead of a pulverized saponin complex.

A subject ate the beef stew and strongly experienced the bitterness peculiar to saponin.

TABLE 4
<Sauce formulation>

| Raw material | Weight (g) |
|---|---|
| Sugar | 1.1 |
| Salt | 1 |
| Tomato paste | 7 |
| Livestock meat extract | 4.4 |
| Wheat roux | 3 |
| Seasoning | 1 |
| Starch | 0.4 |
| Liqueur | 4 |
| Flavor | 0.2 |
| Caramel pigment | 1 |
| Pulverized saponin complex* | 1.5 |
| Water | 75.4 |
| Total | 100 |

*The pulverized saponin complex in Example 1 in an amount corresponding to 0.1 g of a soybean saponin or 0.2 g of a saponin raw material (=Soyhealth SA)

TABLE 5
<Compounding via filling>

| Raw material | Weight (g) |
|---|---|
| Boiled onion | 10 |
| Boiled mushroom | 30 |
| Boiled beef | 40 |
| Sauce | 100 |
| Total | 180 |

### Experiment 5

### Ingredients of Chicken and Egg Bowl

### Example 5

(1) Raw materials were mixed based on the formulation of a sauce (Table 6) other than a whole egg liquid and then heated to 95° C. while undergoing stirring.
(2) The whole egg liquid was added and then the solution was heated to 90° C. while undergoing gently stirring.
(3) Chicken meat and onion to be used as ingredients were cut into bite-size pieces in advance and then boiled for 5 minutes.
(4) A retort pouch (126×170 mm) was filled with the resultant having the formulation in Table 7 and then sealed.
(5) Pressurized heat sterilization was carried out at 120° C. for 20 minutes.
(6) A subject ate the thus obtained ingredients of the chicken and egg bowl, but experienced none of the bitterness peculiar to saponin.

### Comparative Example

Ingredients of a chicken and egg bowl were obtained in a manner similar to that in the Example except that 0.2 parts of a saponin raw material was compounded instead of a pulverized saponin complex.

A subject ate the ingredients of the chicken and egg bowl and strongly experienced the bitterness peculiar to saponin.

TABLE 6
<Sauce formulation>

| Raw material | Weight (g) |
|---|---|
| Bonito extract | 3 |
| Kelp extract | 0.4 |
| Mirin (sweet cooking rice wine)-like seasoning | 1 |
| Sugar | 0.5 |
| Soy sauce | 5 |
| Starch | 2 |
| Flavor | 0.1 |
| Polysaccharide thickener | 0.1 |
| Pulverized saponin complex* | 1.5 |
| Water | 86.4 |
| Whole egg liquid | 30 |
| Total | 130 |

*The pulverized saponin complex in Example 1 in an amount corresponding to 0.1 g of a soybean saponin or 0.2 g of a saponin raw material (=Soyhealth SA)

TABLE 7

| Raw material | Weight (g) |
|---|---|
| Chicken meat | 40 |
| Onion | 10 |
| Sauce | 130 |
| Total | 180.00 |

### Experiment 6

### Chinese Egg Soup Powder

### Example 6

(1) The powdery raw materials in Table 8 were homogenously mixed using a blender, so that a powder formulation was obtained.
(2) An aluminium-containing sack was filled with the resultant measured based on the formulation in Table 9 and then sealed.
(3) Hot water was added to the thus obtained soup powder. Then a subject drank the soup, but experienced none of the bitterness peculiar to saponin.

TABLE 8
<Powder formulation>

| Raw material | Weight (g) |
|---|---|
| Common salt | 1 |
| Livestock meat extract | 1 |
| White sesame | 1 |
| Yeast extract | 0.5 |
| Soy sauce powder | 0.3 |
| Flavor | 1 |
| Seasoning | 0.5 |
| Xanthan gum | 0.2 |
| Pulverized saponin complex* | 1.5 |
| Total | 7 |

*The pulverized saponin complex in Example 1 in an amount corresponding to 0.1 g of a soybean saponin

TABLE 9
<Formulation via filling>

| Raw material | Weight (g) |
|---|---|
| Powder formulation | 7 |
| Beaten egg flake | 1 |
| Dry onion | 0.5 |
| Dry pak-choi | 0.5 |
| Total | 9 |

### Experiment 7

### Complex Prepared Using Phytosterol

### Example 7

A paste complex was obtained by the procedures described in Example 1 except that in the formulation in the Example shown in Table 1, 5 parts by weight of β-sitosterol (Merck & Co., Inc.) was used instead of a phytosterol ester.

The paste complex was dried by maintaining it under an atmosphere at 80° C. for 10 hours, added to a mortar, and then stirred using a stirrer, so that a powdery product was obtained.

The thus obtained powdery product (14.8 g) was dissolved in 85.2 ml of water. A subject drank the solution but experienced almost no bitter taste.

### Experiment 8

### Example 8

The paste complex (21.6 g) produced having the formulation of the Example by the procedures described in Experiment 7 was dissolved in 78.4 ml of water. A retort pouch was filled with 100 g of the thus obtained solution and then sealed. Retort sterilization was carried out under conditions of 120° C. and 20 minutes.

A subject drank the thus obtained retort-sterilized solution, but experienced almost no bitter taste.

### Experiment 9

### Chicken Curry Sauce

### Example 9

A chicken curry sauce was obtained in a manner similar to that in Example 3, except that the pulverized saponin complex of Example 7 was used instead of the pulverized saponin complex of Example 1 in the same amount as that of the pulverized saponin complex of Example 1.

A subject ate the thus obtained chicken curry sauce, but experienced none of the bitterness peculiar to saponin.

All publications, patents, and patent applications cited herein are incorporated herein by reference in their entirety.

1. A complex, containing a saponin, a phytosterol and/or a phytosterol ester, and a cyclodextrin.

2. The complex according to claim 1, which is produced by a method comprising a step of forming a complex by mixing a saponin, a phytosterol and/or a phytosterol ester, and a cyclodextrin in the presence of water.

3. The complex according to claim 2, wherein the method further comprises a drying step of drying the complex formed in the step of forming a complex.

4. A composition, comprising the complex according to claim 1.

5. A food or beverage, comprising the complex according to claim 1.

6. The food or beverage according to claim 5, which is subjected to heat sterilization.

7. The food or beverage according to claim 5, containing a soybean protein and 10 mg to 1000 mg of a saponin per serving.

8. A method for producing a complex containing a saponin, a phytosterol and/or a phytosterol ester, and a cyclodextrin, comprising a step of forming a complex by mixing a saponin, a phytosterol and/or a phytosterol ester, and a cyclodextrin in the presence of water.

9. The method according to claim 8, further comprising a drying step of drying the complex formed in the step of forming a complex.
